(19) United States
(12) Patent Application Publication
(10) Pub. No.: US 2012/0188300 A1
(43) Pub. Date: Jul. 26, 2012

(54) LIQUID EJECTING APPARATUS

(75) Inventor: Junhua Zhang, Shiojiri-shi (JP)

(73) Assignee: SEIKO EPSON CORPORATION, Shinjuku-ku (JP)

(21) Appl. No.: 13/355,446

(22) Filed: Jan. 20, 2012

(30) Foreign Application Priority Data
Jan. 21, 2011 (JP) 2011-010579

(51) Int. Cl. B41J 29/38

(52) U.S. Cl. 347/10

(57) ABSTRACT

The driving signal includes a first element that pressurizes the pressure chamber and that makes the liquid in the nozzle protrude to form a liquid pillar, and a second element that pressurizes the pressure chamber after the first element and that makes a portion of a liquid surface of the liquid, the portion being other than a surface of the liquid pillar, protrude from a position where the liquid surface in the nozzle is in contact with an inner surface of the nozzle, in a direction in which the liquid pillar protrudes, in a state where the liquid pillar has not yet separated from the liquid in the nozzle.

The entire disclosure of Japanese Patent Application No: 2011-010579, filed Jan. 21, 2011 is expressly incorporated by reference herein.

### BACKGROUND

1. Technical Field

The present invention relates to a technology for ejecting a liquid such as ink.

2. Related Art

Heretofore, a liquid ejecting technology has been proposed which is for ejecting a liquid, such as ink, in a pressure chamber in the form of droplets from a nozzle by changing the pressure in the pressure chamber by using a pressure generating element, such as a piezoelectric vibrator or a heating element. When the liquid in the pressure chamber is pressurized, a liquid pillar protrudes from the base surface of the liquid in the nozzle. The top end portion of the liquid pillar is ejected in the form of a large main droplet, whereas the tail portion of the liquid pillar (i.e., the trailing end portion of the liquid pillar) is ejected in the form of satellite droplets that are smaller than the main droplet. Satellite droplets may reach unintended positions on a landing target, such as recording paper, resulting in a decrease in the accuracy of the landing positions, for example, print accuracy. Furthermore, satellite droplets may be dispersed in the form of a mist, making a liquid ejecting apparatus dirty. Accordingly, formation of satellite droplets is desirably suppressed.

In JP-A-11-170518, a single pressure chamber is provided with a piezoelectric element for ejecting ink droplets and a piezoelectric element for suppressing satellite droplets. When ink is ejected, the piezoelectric element for ejecting ink droplets is activated to push out the ink from a nozzle and form an ink pillar. Then, the piezoelectric element for suppressing satellite droplets is also activated to push out the trailing end portion of the ink pillar. As a result, the ink pillar separates and formation of satellite droplets is suppressed.

Regarding the technology disclosed in JP-A-11-170518, a piezoelectric element for suppressing satellite droplets is provided in addition to a piezoelectric element for ejecting an ink droplet, which causes this configuration to be complicated and causes a plurality of piezoelectric elements to need to be individually activated.

### SUMMARY

An advantage of some aspects of the invention is that formation of satellite droplets when liquid is ejected is suppressed by using a simple configuration.

Configurations employed in aspects of the invention will be described. To understand the aspects of the invention easily, correspondences between components of the aspects of the invention and those in the embodiments described below are inserted in parentheses in the description below. However, it is not intended that the scope of the invention be limited to the exemplary embodiments.

According to an aspect of the invention, a liquid ejecting apparatus (for example, a printer 100) includes a liquid ejecting section (for example, a recording head 22) that changes a pressure in a pressure chamber (for example, a pressure chamber 50) by using a pressure generator (for example, a piezoelectric vibrator 422) so as to eject liquid, which is stored in the pressure chamber, in the form of a droplet (for example, an ink droplet B) from a nozzle (for example, a nozzle 56), and a driving-signal generating section (for example, a driving-signal generating section 64) that generates a driving signal (for example, a driving signal COM) which operates the pressure generator. The driving signal includes a first element (for example, a waveform W1) that pressurizes the pressure chamber and that makes the liquid in the nozzle protrude to form a liquid pillar (for example, an ink pillar P), and a second element (for example, an element E5) that pressurizes the pressure chamber after the first element and that makes a portion (for example, a base surface Mb) of a liquid surface (for example, a liquid surface M) of the liquid, the portion being other than a surface of the liquid pillar, protrude from a position where the liquid surface in the nozzle is in contact with an inner surface of the nozzle, in a direction in which the liquid pillar protrudes, in a state where the liquid pillar has not yet separated from the liquid in the nozzle.

With the above-described configuration, a first element is supplied to form a liquid pillar which extends from a base surface of liquid, and a second element is then supplied in the state where the liquid pillar has not yet separated from the liquid in a nozzle. As a result, the liquid surface of the liquid, which is a portion other than the surface of the liquid pillar (that is, the base surface of the liquid), is made to protrude. Accordingly, the tail portion of the liquid pillar becomes thin, and surface tension acts on the base surface in a direction toward a discharge surface from which the portion of the liquid surface protrudes. Consequently, the liquid surface easily separates. Thus, formation of satellite droplets is suppressed when a droplet forms, compared with a configuration in which the base surface of liquid does not protrude in the state where a liquid pillar has not yet separated from the liquid in a nozzle.

The term “after a first element” encompasses two meanings: just after the first element ends; and when a certain time period has elapsed after the first element ends. In general, the term “after an element” herein encompasses two meanings: just after the element ends; and when a certain time period has elapsed after the element ends. Similarly, the term “before an element” herein encompasses two meanings: just before the element starts; and at a time point a certain time period earlier than when the element starts.

It is preferable that the driving signal further include a third element (for example, an element E4) that is maintained at a potential supplied at the end of the first element after the first element and before the second element. With the above-described configuration, the pressure generator is not activated during the supply of the third element. Accordingly, this configuration is more advantageous for forming a liquid pillar in a state where the liquid pillar has not yet separated from the liquid in the nozzle.

It is preferable that the first element include a depressurization element (for example, an element E1) that causes a potential change of a first potential difference in a first direction from a certain reference potential (for example, a reference potential VREF) so as to decrease the pressure in the pressure chamber, and a pressurization element (for example, an element E3) that causes a potential change of a second potential difference (for example, an amount of potential change Ae3), which is greater than the first potential difference, in a second direction opposite to the first direction so as to pressurize the pressure chamber. With the above-described configuration, the decrease in the pressure in the pressure chamber is caused by the depressurization element prior to the increase in the pressure in the pressure chamber caused by the pressurization element. Thus, the liquid surface is temporarily drawn back toward the pressure chamber. Accordingly, a liquid pillar is more efficiently formed when the pressure is applied by the pressurization element supplied later. In addition, the second potential difference is greater than the first potential difference. As a result, a larger amount of liquid is ejected, compared with a configuration in which the second potential difference is equal to or less than the first potential difference.

It is preferable that the driving signal further include a fourth element (for example, an element E4a) that decreases the pressure in the pressure chamber after the first element and before the second element. The above-described configuration has an advantage that excessive vibration of the pressure chamber is suppressed and that the amplitude of the driving signal is reduced, leading to a reduction in power consumption, compared with a configuration in which the potential is maintained at the potential supplied at the end of the first element, in a time period between the end of the first element and the start of the second element.

It is preferable that a gradient of a potential change of the fourth element be smaller than a gradient of a potential change of the second element. With the above-described configuration, the degree to which the liquid surface is changed is further reduced.

It is preferable that the driving signal further include an element (for example, an element E7) that decreases the pressure in the pressure chamber after the second element. With the above-described configuration, the pressure chamber is pressurized after the pressurization by the second element.

It is preferable that an amplitude of a potential change of the second element (for example, an amount of potential change Ae5) be within two-fifths of an amplitude of a potential change of the first element (for example, an amount of potential change Ae3). With the above-described configuration, a degree of the pressurization in the second step for protruding the base surface of the liquid is smaller than that in the first step for protruding the liquid pillar.

It is preferable that the second element be started when the height (for example, a height PL) of the liquid pillar, which is formed by the first element, with respect to a discharge surface ranges from twice to five times the diameter (for example, a diameter d) of the nozzle. With the above-described configuration, a situation is avoidable in which a droplet is hardly formed because a liquid pillar is too short or in which an adequate-sized droplet is hardly formed because a liquid pillar is too long.

It is preferable that the height (for example, a height h) of the liquid surface, which is made to protrude by the second element, with respect to a discharge surface range from a half the diameter of the nozzle to three and a half times the diameter of the nozzle. With the above-described configuration, formation of satellite droplets is effectively suppressed.

### BRIEF DESCRIPTION OF THE DRAWINGS

The invention will be described with reference to the accompanying drawings, wherein like numbers reference like elements.

FIG. 1 is a partial diagrammatic representation illustrating a printer according to a first embodiment of the invention.

FIG. 2 is a sectional view illustrating a recording head according to the first embodiment.

FIG. 3 is a block diagram illustrating an electrical configuration of the printer.

FIG. 4 is a block diagram illustrating an electrical configuration of the recording head.

FIG. 5 is a diagram illustrating the waveform of a driving signal according to the first embodiment.

FIG. 6 includes time-series diagrams illustrating how an ink droplet is ejected, according to the first embodiment.

FIG. 7 is a diagram illustrating correspondences between time points for the driving signal and the times for the diagrams in FIG. 6.

FIG. 8 is a diagram illustrating an exemplary waveform of a comparative driving signal.

FIG. 9 includes time-series diagrams illustrating how an ink droplet is ejected in the case of the comparative driving signal.

FIG. 10 is a diagram illustrating correspondences between time points for the comparative driving signal and the times for the diagrams in FIG. 9.

FIGS. 11A and 11B are diagrams illustrate the states just before the ejection of an ink droplet according to the comparative example and the first embodiment.

FIG. 12 is a diagram illustrating the waveform of a driving signal according to a second embodiment of the invention.

FIG. 13 is a diagram illustrating an exemplary waveform modification of the driving signal.

FIG. 14 is a diagram illustrating another exemplary waveform modification of the driving signal.

### DESCRIPTION OF EXEMPLARY EMBODIMENTS

### First Embodiment

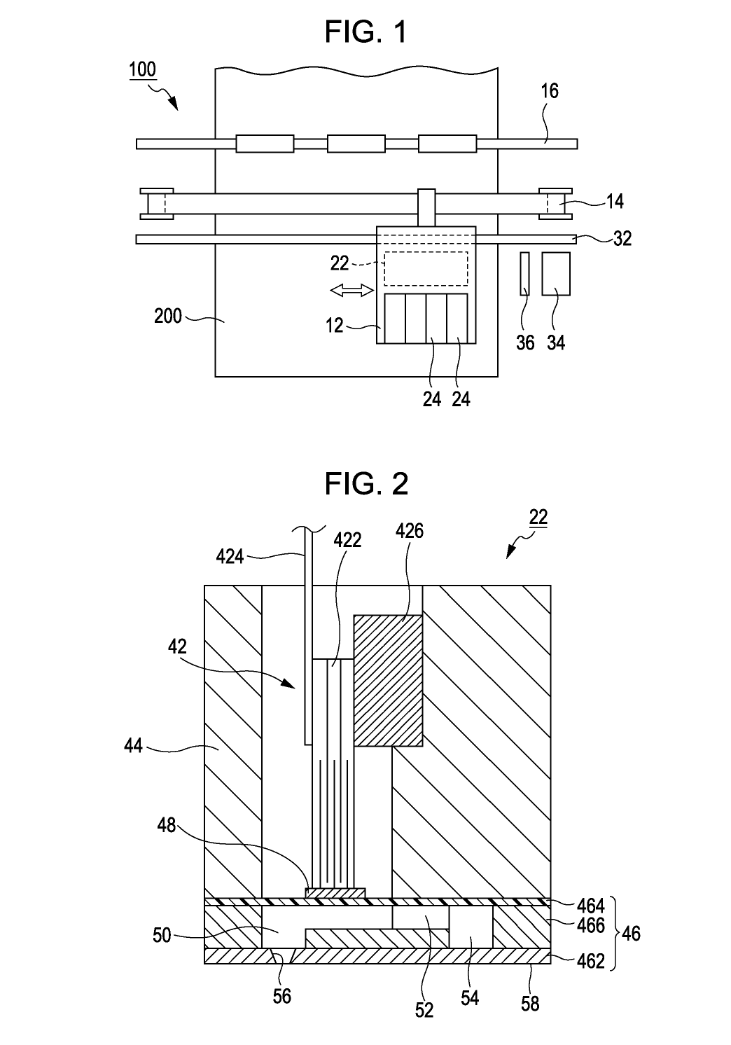

FIG. 1 is a partial diagrammatic representation illustrating an ink-jet printer 100 according to a first embodiment of the invention. The printer 100 is a liquid ejecting apparatus that ejects fine ink droplets onto recording paper 200. The printer 100 includes a carriage 12, a moving mechanism 14, and a sheet transporting mechanism 16. The carriage 12 has a recording head 22 installed therein which serves as a liquid ejecting section. The carriage 12 also has ink cartridges 24 that are removably mounted thereon and that store inks supplied to the recording head 22. An alternative configuration may be employed in which the ink cartridges 24 which are fixed to a case (not illustrated) of the printer 100 are used for supplying inks to the recording head 22.

The moving mechanism 14 reciprocates the carriage 12 along a guide shaft 32 in the main scanning direction (i.e., in the width direction of the recording paper 200, which is indicated by the arrow in FIG. 1). The position of the carriage 12 is detected by a detector (not illustrated), such as a linear encoder, and the detected position is used for the control of the moving mechanism 14. The sheet transporting mechanism 16 transports the recording paper 200 in the sub scanning direction while the carriage 12 is reciprocating. While the carriage 12 is reciprocating, the recording head 22 ejects ink droplets onto the recording paper 200, and a desired image is recorded (printed) on the recording paper 200. A cap 34 for sealing a discharge surface of the recording head 22, and a wiper 36 for wiping the discharge surface are installed near an end point of the reciprocation of the carriage 12.

FIG. 2 is a sectional view illustrating the recording head 22, taken along a line perpendicular to the main scanning direction. As illustrated in FIG. 2, the recording head 22 includes vibrating units 42, a housing body 44, and a channel unit 46. Each of the vibrating units 42 includes a piezoelectric vibrator 422, a cable 424, and a fixing plate 426. The piezoelectric vibrator 422 is a piezoelectric element that generates longitudinal vibration, and has multiple layers in which a piezoelectric material and an electrode are alternately stacked one on top of the other. The piezoelectric vibrator 422 vibrates in accordance with a driving signal supplied through the cable 424. The piezoelectric vibrator 422 is fixed to the fixing plate 426. The vibrating unit 42 is housed in the housing body 44 with the fixing plate 426 being joined to an internal surface of the housing body 44.

The channel unit 46 has a structure in which a channel forming board 466 is inserted between substrates 462 and 464 which face to each other. The channel forming board 466 forms spaces including pressure chambers 50, supply channels 52, and reservoirs 54, in the gap between the substrate 462 and the substrate 464. The pressure chambers 50 are partitioned with division walls for the corresponding vibrating units 42. Each of the pressure chambers 50 communicates with a corresponding one of the reservoirs 54 through a corresponding one of the supply channels 52. The pressure chambers 50 have nozzles (orifices) 56 which are arranged in a line in the substrate 462. A discharge surface 58 is a surface of the substrate 462 on the other side of the substrate 462 from the pressure chambers 50. Each of the nozzles 56 is a through hole through which the corresponding pressure chamber 50 communicates with the outside. Ink supplied from each of the ink cartridges 24 is stored in the corresponding reservoir 54. As apparent from the above description, an ink channel is formed from the reservoir 54 through the supply channel 52, the pressure chamber 50, and the nozzle 56 to the outside.

The substrate 464 is a planar plate formed of an elastic material. Island sections 48 having an island shape are formed on the surface of the substrate 464 in a region on the other side of the substrate 464 from the pressure chambers 50. The substrate 464 that forms part of the pressure chambers 50, and the island sections 48 constitute a vibrating plate that is deformed and vibrates by means of the driving of the piezoelectric vibrators 422. Each of the island sections 48 is joined to an end surface (free end) of the piezoelectric vibrator 422. Accordingly, when the piezoelectric vibrator 422 is driven by means of the supply of the driving signal, the substrate 464 is displaced through the island section 48, leading to a change in the volume of the pressure chamber 50 and to a change in the ink pressure in the pressure chamber 50. That is, the piezoelectric vibrator 422 serves as a pressure generator for changing the pressure in the pressure chamber 50. An ink droplet is ejected from the nozzle 56 in accordance with the change in the pressure in the pressure chamber as described above.

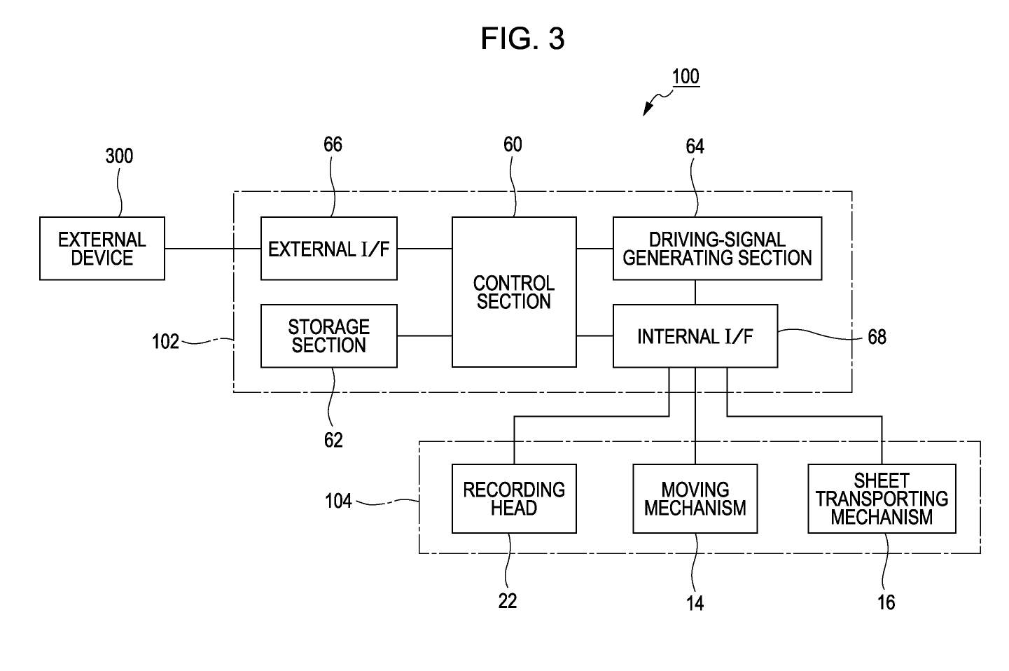

FIG. 3 is a block diagram illustrating an electrical configuration of the printer 100. As illustrated in FIG. 3, the printer 100 includes a controller 102 and a printing processing section (print engine) 104. The controller 102 is a component that controls the entire printer 100, and includes a control section 60, a storage section 62, a driving-signal generating section 64, an external interface (I/F) 66, and an internal I/F 68. The external I/F 66 is supplied with print data that designates an image to be printed on the recording paper 200, from an external device (for example, a host computer) 300. The printing processing section 104 is connected to the internal I/F 68. The printing processing section 104 is a component that records an image on the recording paper 200 under the control of the controller 102. The printing processing section 104 includes the recording head 22, the moving mechanism 14, and the sheet transporting mechanism 16 which are described above.

The storage section 62 includes a ROM for storing control programs, for example, and a RAM for temporarily storing various data that is used for printing an image (i.e., for ejecting ink droplets through the individual nozzles 56). The control section 60 executes the control programs stored in the storage section 62 so as to control the components (for example, the moving mechanism 14 and the sheet transporting mechanism 16 of the printing processing section 104) of the printer 100 integrally. The control section 60 converts the print data supplied from the external device 300 through the external I/F 66, into ejection data D for instructing the individual piezoelectric vibrators 422 to eject or not to eject ink droplets from the corresponding nozzles 56 of the recording head 22. The driving-signal generating section 64 generates a driving signal COM and supplies the generated driving signal COM to the recording head 22 through the internal I/F 68. The driving signal COM is a periodical signal for driving the piezoelectric vibrators 422 to eject ink droplets through the nozzles 56 of the pressure chamber 50.

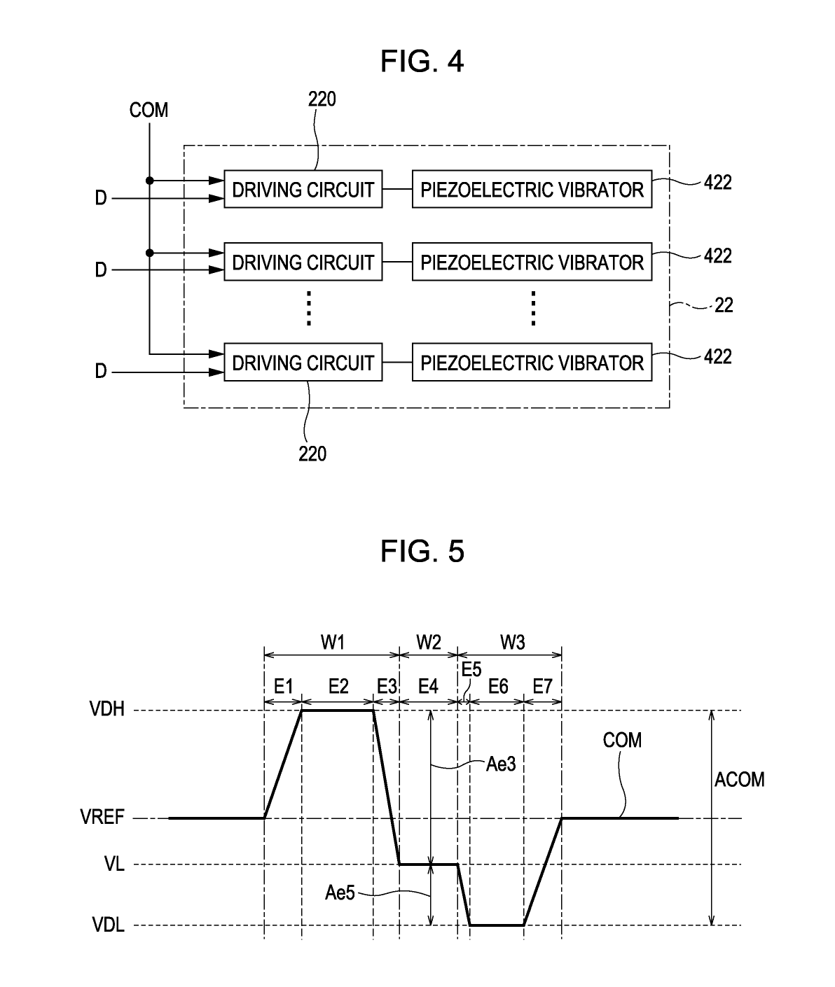

FIG. 4 is a block diagram illustrating an electrical configuration of the recording head 22. As illustrated in FIG. 4, the recording head 22 includes driving circuits 220 corresponding to the different nozzles 56 (i.e., the piezoelectric vibrators 422). A single driving signal COM is supplied to the driving circuits 220. The ejection data D generated by the control section 60 is individually supplied to each of the driving circuits 220 through the internal I/F 68.

Each of the driving circuits 220 supplies the piezoelectric vibrator 422 with the driving signal COM in accordance with the ejection data D. For example, when the ejection data D indicates an instruction to eject an ink droplet, the driving circuit 220 supplies the driving signal COM to the piezoelectric vibrator 422 to drive the piezoelectric vibrator 422, thereby causing the vibrating plate (i.e., the island section 48 and the substrate 464) to vibrate. This vibration of the substrate 464 pressurizes the pressure chamber 50, resulting in ejection of an ink droplet from the nozzle 56 onto the recording paper 200. When the ejection data D indicates an instruction not to eject the ink (stopping of ejection), the driving circuit 220 does not supply the driving signal COM to the piezoelectric vibrator 422. Accordingly, no ink droplets are ejected from the nozzle 56 of the pressure chamber 50. Alternatively, when the ejection data D indicates an instruction not to eject the ink, the driving circuit 220 may supply the driving signal COM to the piezoelectric vibrator 422 to drive the piezoelectric vibrator 422 and vibrate the vibrating plate (i.e., the island section 48 and the substrate 464) in such a manner that no ink droplets are ejected. In this manner, the liquid in the pressure chamber 50 and in the nozzle 56 is subjected to fine vibration through the substrate 464. In this case, the ink is not ejected from the pressure chamber 50 and is, instead, stirred adequately.

FIG. 5 illustrates a cycle of an exemplary waveform of the driving signal COM generated by the driving-signal generating section 64. In FIG. 5, the vertical axis represents potential, and the horizontal axis represents time. Time progresses from left to right in FIG. 5. As illustrated in FIG. 5, the driving signal COM has a waveform in which the potential varies between a potential VDH and a potential VDL. The driving signal COM has a waveform having a first waveform W1, a second waveform W2, and a third waveform W3 which are connected in this sequence.

The first waveform W1 includes an element E1, which increases from a certain reference potential VREF to the potential VDH that is on the high potential side, an element E2, which is maintained at the potential VDH, and an element E3, which decreases from the potential VDH to a potential VL that is on the low potential side (VL<VREF<VDH). When the element E1 is supplied, the piezoelectric vibrator 422 acts so that the pressure in the pressure chamber 50 is decreased. In other words, the vibrating plate (i.e., the island section 48 and the substrate 464) is displaced so that the pressure chamber 50 expands. When the element E2 is supplied, the action of the piezoelectric vibrator 422 (i.e., the displacement of the vibrating plate) is stopped with the pressure in the pressure chamber 50 being maintained at the pressure supplied at the end of the element E1. When the element E3 is supplied, the piezoelectric vibrator 422 acts so that the pressure chamber 50 is pressurized. That is, the vibrating plate (i.e., the island section 48 and the substrate 464) is displaced so that the pressure chamber 50 shrinks.

The second waveform W2 follows the first waveform W1 and couples the first waveform W1 to the third waveform W3. The second waveform W2 is constituted by an element E4 which is maintained at the potential VL supplied at the end of the first waveform W1 (i.e., the element E3). Accordingly, the pressurization of the pressure chamber 50 is stopped.

The third waveform W3 follows the second waveform W2. The third waveform W3 includes an element E5, which decreases from the potential VL supplied at the end of the second waveform W2 (i.e., the element E4), to the potential VDL that is on the potential side lower than the potential VL (VDL<VL), an element E6, which is maintained at the potential VDL, and an element E7, which increases from the potential VDL to the reference potential VREF. When the element E5 is supplied, the piezoelectric vibrator 422 displaces the vibrating plate (i.e., the island section 48 and the substrate 464) so that the pressure chamber 50 further shrinks, which causes the pressure chamber 50 to be further pressurized. When the element E6 is supplied, the action of the piezoelectric vibrator 422 is stopped with the pressure in the pressure chamber 50 being maintained at the pressure supplied at the end of the element E5. When the element E7 is supplied, the piezoelectric vibrator 422 acts so that the pressure in the pressure chamber 50 is decreased. That is, the vibrating plate (i.e., the island section 48 and the substrate 464) is displaced so that the pressure chamber 50 expands.

As described above, the driving signal COM implements a two-step pressurization process, in which the first pressurization (by the element E3 of the first waveform W1), the pressure maintenance (by the element E4 of the second waveform W2), and the second pressurization (by the element E5 of the third waveform W3) are performed in this sequence. A time period and the amount of potential change of each element of the driving signal COM are set as appropriate. For example, as illustrated in FIG. 5, the amount of potential change Ae5 of the element E5 (Ae5=VL−VDL) is smaller than the amount of potential change Ae3 of the element E3 (Ae3=VDH−VL). Specifically, it is preferable that the amount of potential change Ae5 of the element E5 be set within two-fifths of the amount of potential change Ae3 of the element E3.

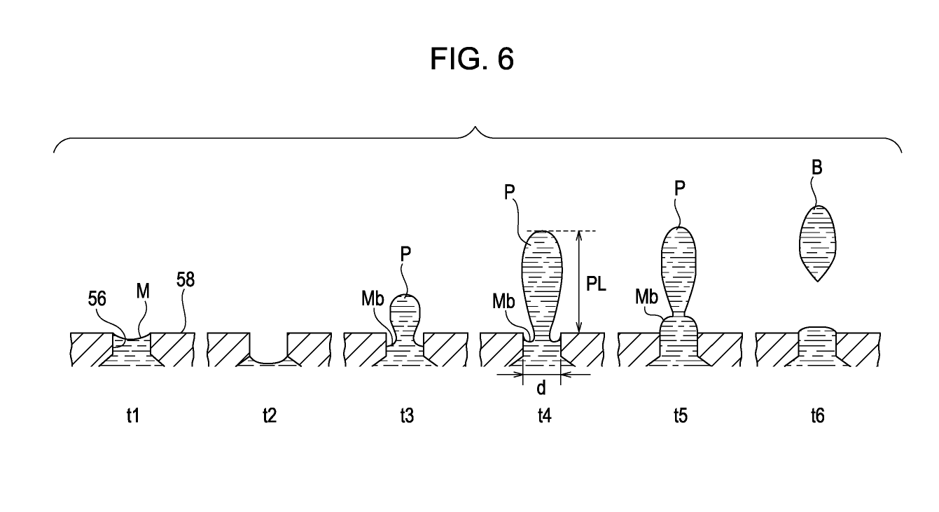

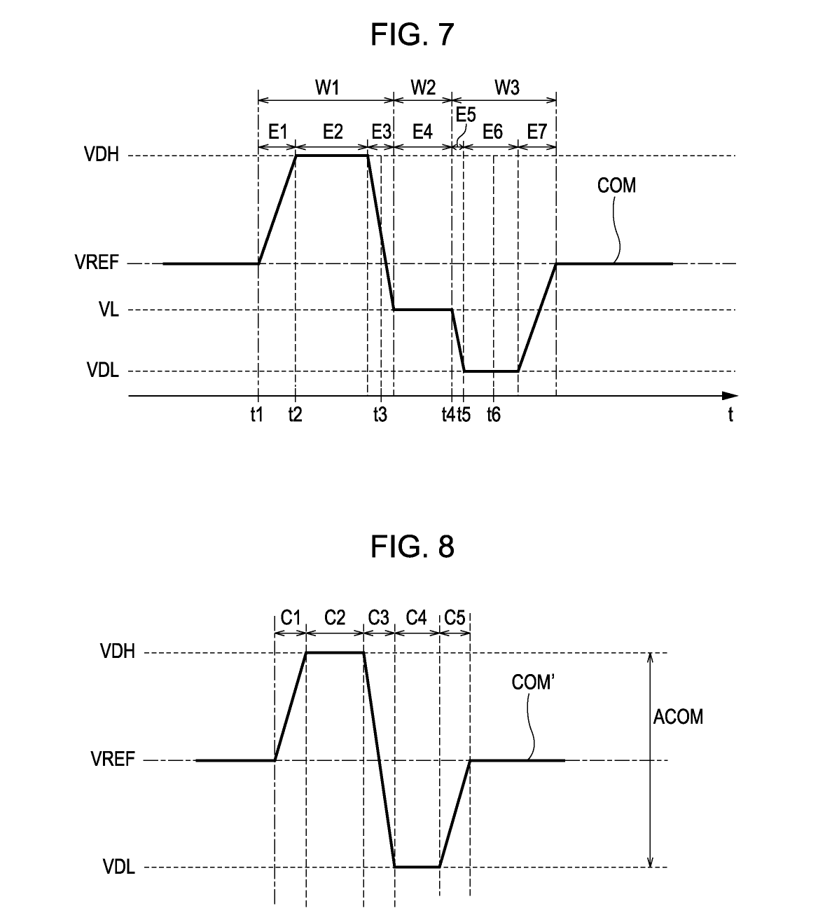

FIG. 6 illustrates how an ink droplet B is ejected from the nozzle 56 of the pressure chamber 50 when the driving signal COM is supplied. FIG. 6 includes sectional views of the nozzle 56, and illustrates how a liquid surface M of ink is displaced due to the changes in the pressure in the pressure chamber 50 and the ink droplet B is ejected, in a time-series manner (at times t1 to t6). In FIG. 6, the direction toward the upper side of the figure represents a direction toward the outside of the pressure chamber 50, and the lower side, toward the inside of the pressure chamber. That is, the nozzle direction of FIG. 6 is opposite to that of FIG. 2. FIG. 7 is a diagram illustrating correspondences between the time points for the driving signal COM and times t1 to t6 in FIG. 6.

At time t1, the driving signal COM having the reference potential VREF is supplied to the piezoelectric vibrator 422. Accordingly, the vibrating plate (i.e., the island section 48 and the substrate 464) is not displaced, and the pressure in the pressure chamber 50 is not increased or decreased. As a result, the liquid surface M of the ink is slightly recessed due to the surface tension thereof (at time t1 in FIG. 6).

After the time t1, the element E1, which increases to the potential VDH on the high potential side, is supplied to the piezoelectric vibrator 422, which causes the pressure chamber 50 to expand and causes the pressure therein to be decreased. Through the decrease in the pressure, the liquid surface M of the ink is pulled toward the inside of the pressure chamber 50, and is drawn away from the discharge surface 58 (at time t2 in FIG. 6).

After time t2, when the element E2 which is maintained at the potential VDH ends, the element E3, which decreases to the potential VL on the low potential side, is supplied to the piezoelectric vibrator 422, which causes the pressure chamber 50 to shrink rapidly and causes the pressure therein to be increased. Through the pressurization, the liquid surface M of the ink moves toward the outside of the pressure chamber 50 (i.e., the ejection direction of the ink droplet B), and the ink protrudes from a base surface Mb of the ink in the nozzle 56 (i.e., the liquid surface M of the ink other than the surface of an ink pillar P). As a result, the ink pillar P is formed (at time t3 in FIG. 6).

After time t3, when the element E3 ends, the element E4, which is maintained at the potential VL supplied at the end of the element E3, is supplied to the piezoelectric vibrator 422. Through the supply of the element E4, the pressurization in the pressure chamber 50 is stopped. However, the ink pillar P further extends due to an inertial force generated when the ink pillar P protrudes from the nozzle 56. At time t4 after time t3, the ink pillar P does not separate from the base surface Mb of the ink (at time t4 in FIG. 6).

In the state where the ink pillar P does not separate from the base surface Mb of the ink, the element E5, which decreases to the potential VDL on the lower potential side, is supplied to the piezoelectric vibrator 422, which causes the pressure chamber 50 to further shrink and causes the pressure therein to be increased. Through the increase in the pressure, the base surface Mb of the ink is pushed from the discharge surface 58 (at time t5 in FIG. 6). Preferably, the element E5 starts when the height PL of the ink pillar P with respect to the discharge surface 58 ranges, for example, from twice to five times the diameter d of the nozzle 56 (2d≦PL≦d). The diameter d of the nozzle 56 is, for example, on the order of 10 to 90 μm. The supply of the element E5 starts, for example, 5 to 15 microseconds after the supply of the element E3 starts.

When the element E5 ends at time t5, the element E6, which is maintained at the potential VDL supplied at the end of the element E5, is supplied to the piezoelectric vibrator 422. The ink pillar P still extends due to the inertial force. At time t6, the ink pillar P separates from the base surface Mb that has a protrusion, and a single ink droplet B is formed (at time t6 in FIG. 6). The ink droplet B which has separated flies due to the inertial force. The ink droplet B has a flying speed on the order of 5 to 10 m/sec, for example. Then, the element E7, which increases to the reference potential VREF, is supplied to the piezoelectric vibrator 422. As a result, the pressure in the pressure chamber 50 is decreased.

A comparative example will be described in which a typical driving signal COM′ is used for ejecting an ink droplet B, instead of the driving signal COM according to the first embodiment. In this comparative example, the diameter of the tail portion of an ink pillar P becomes large, and the ink pillar P significantly extends. Accordingly, when the ink pillar P separates and the ink droplet B (the main droplet) is formed, satellite droplets S are formed.

FIG. 8 illustrates the waveform of the typical driving signal COM′. As illustrated in FIG. 8, the driving signal COM′ has a waveform in which the potential varies between the potential VDH and the potential VDL. The driving signal COM′ includes a first element C1, which increases from the certain reference potential VREF to the potential VDH that is on the high potential side, a second element C2, which is maintained at the potential VDH, a third element C3, which decreases from the potential VDH to the potential VDL that is on the low potential side, a fourth element C4, which is maintained at the potential VDL, and a fifth element C5, which increases from the potential VDL to the reference potential VREF. In this comparative example, the reference potential VREF, the potential VDH, and the potential VDL are set to the same values as those in the first embodiment. Accordingly, the amplitude ACOM of the driving signal COM′ is equal to that of the driving signal COM.

Similar to the first waveform W1 (the elements E1 and E2) according to the first embodiment, after the first element C1 and the second element C2 are supplied to decrease the pressure in the pressure chamber 50, the third element C3 is supplied to pressurize the pressure chamber 50. The amount of potential change of the third element C3 is equal to the amplitude ACOM of the driving signal COM′ (ACOM=VDH−VDL), and is larger than the amount of potential change Ae3 (Ae3=VDH−VL) of the element E3 of the first waveform W1 according to the first embodiment. Accordingly, the change in the pressure in the pressure chamber 50 which is caused by the third element C3 is greater than that caused by the element E3 of the first waveform W1. When the third element C3 ends, similar to the third waveform W3 (the elements E6 and E7) according to the first embodiment, the fourth element C4 and the fifth element C5 are supplied to decrease the pressure in the pressure chamber 50.

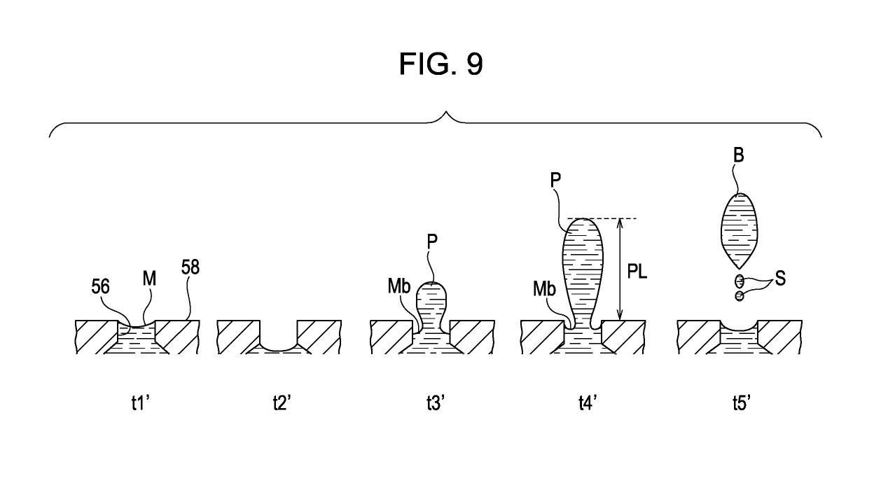

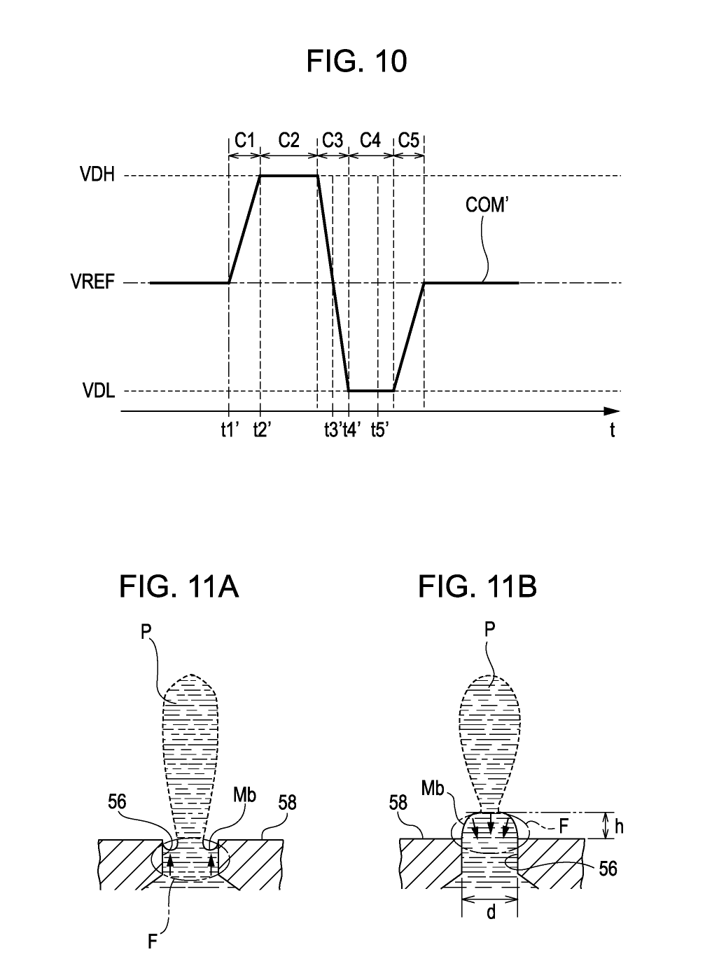

FIG. 9 illustrates how the ink droplet B is ejected from the nozzle 56 of the pressure chamber 50 by using the typical driving signal COM′. Similar to FIG. 6, the nozzle direction of FIG. 9 is opposite to that of FIG. 2. FIG. 10 is a diagram illustrating correspondences between the time points for the driving signal COM′ and times t1′ to t5′ in FIG. 9. States of the liquid surface M at times t1′ to t3′ illustrated in FIG. 9 are similar to those at times t1 to t3 illustrated in FIG. 6, and will not be described.

As described above, the change in the pressure in the pressure chamber 50 which is caused by the third element C3 of the driving signal COM′ is greater than that caused by the element E3 of the first waveform W1 of the driving signal COM. When the third element C3 ends at time t4′, the fourth element C4, which is maintained at the potential VDL that is the potential supplied at the end of the third element C3, is supplied to the piezoelectric vibrator 422. At time t4′, the base surface Mb of the ink is recessed (at time t4′ in FIG. 9).

Through the supply of the fourth element C4, the pressurization of the pressure chamber 50 is stopped. However, the ink pillar P further extends due to the inertial force generated when the ink pillar P protrudes from the nozzle 56. At time t5′, the ink pillar P separates from the base surface Mb which is recessed, and an ink droplet B and satellite droplets S are formed (at time t5′ in FIG. 9). The ink droplet B, which has separated, and the satellite droplets S fly due to the inertial force. The speed of the satellite droplets S is likely to reduce because the satellite droplets S have a small particle diameter and small mass, and the satellite droplets S fly at a speed slower than that of the ink droplet B which is the main droplet. Accordingly, the satellite droplets S may reach the recording paper 200 later than the main droplet, and dots may be formed at unintended positions, resulting in a decrease in print accuracy. The satellite droplets S may not reach the recording paper 200 and may be dispersed in the form of a mist, making the printer 100 dirty.

Referring to FIGS. 11A and 11B, the formation of the satellite droplets S will be described. FIGS. 11A and 11B illustrate the states just before the ejection of the ink droplet B according to the comparative example and the first embodiment, respectively, for the purpose of comparison. Referring to FIG. 11A, the comparative example will be described in which the base surface Mb is not pushed out in the state where the ink pillar P is formed. Since surface tension acts in such a direction that a liquid surface becomes smaller, surface tension F acts on the base surface Mb in the nozzle 56 toward the outside of the pressure chamber 50 (i.e., the ejection direction of the ink droplet B). Accordingly, the diameter of the tail portion of the ink pillar P becomes larger, and the ink pillar P does not easily separate, which causes the ink pillar P to extend long from the base surface Mb in the state where the ink pillar P does not separate from the base surface Mb. Since the diameter of the tail portion of the ink pillar P becomes larger, the ink pillar P will not separate until a distance PL between the top end of the ink pillar P and the discharge surface 58 of the nozzle 56 becomes significantly long. In the case where the ink pillar P separates when the distance PL is significantly long, not only is the ink droplet B (the main droplet) formed from the top end portion of the ink pillar P, but also the satellite droplets S are formed from the tail portion of the ink pillar P.

On the other hand, according to the first embodiment (see FIG. 11B), the base surface Mb is pushed out in the state where the ink pillar P is formed. Since the surface tension F acts on the base surface Mb toward the inside of the pressure chamber 50 (i.e., such a direction that the base surface Mb which protrudes becomes smaller), the ink pillar P easily separates from the base surface Mb. Thus, the ink pillar P separates before extending to a length equal to that in the comparative example, and the formation of the satellite droplets S is suppressed when the ink droplet B is ejected. The effect of the suppression of the satellite droplets S is enhanced when a height h ranges from a half the diameter d of the nozzle 56 to three and a half times the diameter d ((1/2)d≦h≦(3/2)d), where the height h is that of the base surface Mb of the ink, which is pushed out by the supply of the element E5 of the third waveform W3. The height h is the distance between the top end of the base surface Mb and the discharge surface 58.

As described above, according to the first embodiment, the element E5 is supplied to push out the base surface Mb in the state where the ink pillar P formed by the supply of the element E3 extends from the base surface Mb.

With the above-described configuration, the ink pillar P easily separates in comparison with the case where the driving signal COM′ in FIG. 8 is supplied to eject the ink droplet B (i.e., the case where the ink droplet B is ejected in a single step of pressurization without a maintaining step). As a result, formation of the satellite droplets S is suppressed when the ink droplet B is ejected.

In addition, the driving signal COM that includes two steps of pressurization is supplied to a single piezoelectric vibrator 422 to be activated. Thus, with a simple configuration using a single piezoelectric vibrator, formation of satellite droplets is suppressed when an ink droplet is ejected, in comparison with a configuration in which a plurality of piezoelectric elements are provided which correspond to the steps of pressurization and are individually activated.

### Second Embodiment

A second embodiment of the invention will be described below. According to the first embodiment, the potential supplied at the end of the first waveform W1 is maintained in the second waveform W2. According to the second embodiment, the second waveform W2 includes an element for decreasing the pressure in the pressure chamber 50. In the exemplary aspects of the invention described below, elements having actions and functions that are equivalent to those of the first embodiment are denoted by the same reference characters, and will not be described in detail as appropriate.

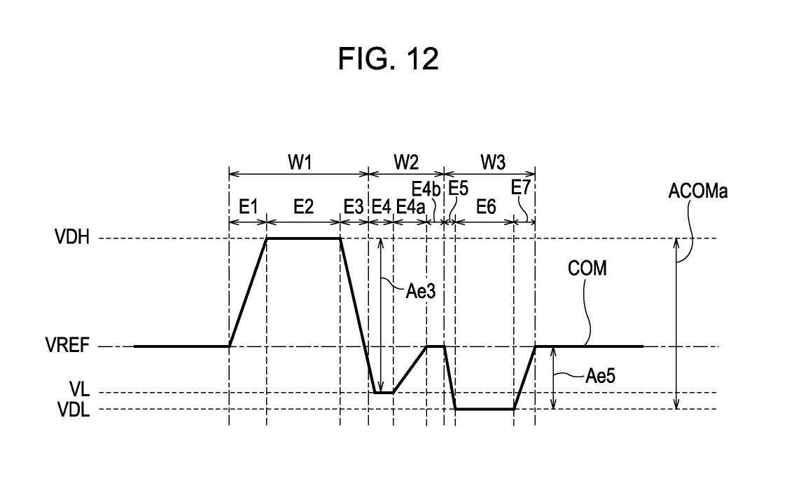

Referring to FIG. 12, a cycle of the waveform of the driving signal COM of the second embodiment will be described. Similar to FIG. 5, the vertical axis of FIG. 12 represents potential, and the horizontal axis represents time. Time progresses from left to right in FIG. 12. The driving signal COM has a waveform having the first waveform W1, a second waveform W2, and a third waveform W3 which are connected in this sequence. The element E5 of the third waveform W3 decreases from the potential supplied at the end of an element E4b of the second waveform W2 described below.

The second waveform W2 includes the element E4, which is maintained at the potential VL supplied at the end of the first waveform W1 (i.e., the element E3), an element E4a, which changes up to the reference potential VREF in such a manner that the pressure in the pressure chamber 50 is decreased, and the element E4b, which is maintained at the reference potential VREF. The element E4a which increases is provided before the element E5 and after the element E3, both of which decrease. Accordingly, the amplitude ACOMa of the driving signal COM according to the second embodiment is smaller than the amplitude ACOM of the driving signal COM in which the element E5 decreases from the potential VL supplied at the end of the element E4. Thus, excessive vibration of the pressure chamber 50 is suppressed, and the power consumption is reduced. Furthermore, the amount of potential change Ae3 (Ae3=VDH−VL) caused by the element E3 and the amount of potential change Ae5 (Ae5=VREF−VDL) caused by the element E5 are equivalent to those of the first embodiment. These amounts of potential change lead to the protrusion and ejection of the ink. Accordingly, the ink droplet B is ejected as in the aspects illustrated in FIG. 6.

In short, according to the second embodiment, the effect of the suppression of the satellite droplets S is achieved similar to the first embodiment. Moreover, other advantageous effects are achieved which are the suppression of excessive vibration of the pressure chamber 50 and the reduction in the power consumption.

The gradient of the potential change of the element E4a is preferably smaller than that of the element E3 of the first waveform W1 and that of the element E5 of the third waveform W3, as illustrated in FIG. 12. In this case, a displacement of the liquid surface M of the ink is further reduced.

The potential which is supplied at the end of the element E4a and which is maintained in the element E4b is not limited to the reference potential VREF, and may be set to a higher or lower potential. The second waveform W2 may not include the element E4b, and the third waveform W3 (i.e., the element E5) may start just after the element E4a ends. In other words, as long as the potential is not changed in such a manner that the pressure chamber 50 is pressurized from the potential supplied at the end of the first waveform W1 (i.e., the element E3), the second waveform W2 may have any form. However, as described in the first embodiment, the amount of potential change Ae5 of the element E5 is preferably smaller than the amount of potential change Ae3 of the element E3. Specifically, it is preferable that the amount of potential change Ae5 be set within two-fifths of the amount of potential change Ae3.

As can be understood from the above-described exemplary embodiments, the second waveform W2 according to the first or second embodiment is encompassed as an element for stopping pressurization of the pressure chamber 50 (i.e., an element for not increasing the potential from the potential supplied at the end of the first waveform W1). The second waveform W2 is defined as a concept including at least one of the elements E4 (according to the first embodiment), which is maintained at a level, and E4a (according to the second embodiment), which decreases.

### Exemplary Modifications

The above-described embodiments may be modified into various forms. Specific exemplary modified aspects will be described below. Any two or more of the exemplary modified aspects may be combined as appropriate.

### First Exemplary Modification

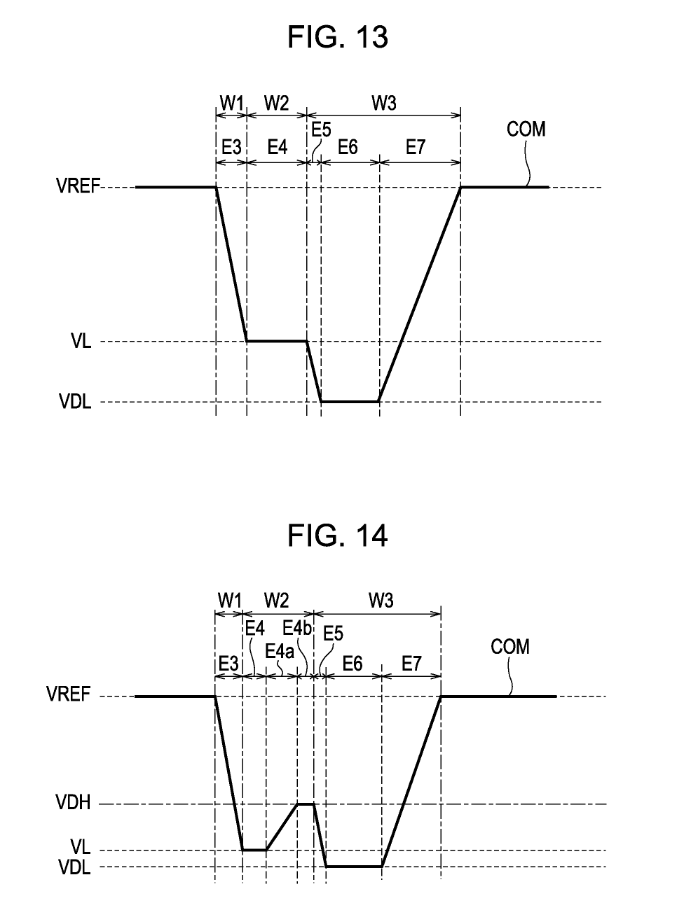

The waveform of the driving signal COM may be modified as appropriate. For example, according to the first embodiment, the element E1 which increases to the potential VDH on the high potential side and the element E2 which is maintained at the potential VDH are provided at the beginning of the first waveform W1. However, as illustrated in FIG. 13, the first waveform W1 may not include the element E1 nor the element E2, and the element E3 may first decrease from the reference potential VREF to the potential VL that is on the low potential side, for example. This exemplary modification may be applicable to the driving signal COM according to the second embodiment. Specifically, as illustrated in FIG. 14, the first waveform W1 may not include the element E1 nor the element E2, and the element E3 may first decrease from the reference potential VREF to the potential VL that is on the low potential side.

### Second Exemplary Modification

The second waveform W2 may not be provided, and a driving signal COM may be employed which is constituted by the first waveform W1 and the third waveform W3. In other words, the driving signal COM does not have any of the element E4, the element E4b, both of which are maintained at a level, and the element E4a which decreases. Accordingly, the driving signal COM may have the third waveform W3 just after the first waveform W1. Since the second waveform W2 is not provided, the time period for a cycle of the driving signal COM is decreased, and the speed of the printing operation is increased. With this configuration, the gradient of the potential change of the element E3 of the first waveform W1 and the gradient of the potential change of the element E5 of the third waveform W3 are set at different values such that the supply of the element E3 causes the ink in the nozzle 56 to protrude to form the ink pillar P and that the supply of the element E5 causes the base surface Mb to protrude in the direction of the protrusion of the ink pillar P in the state where the ink pillar P has not yet separated from the ink in the nozzle 56.

### Third Exemplary Modification

According to the above-described embodiments, the piezoelectric vibrator 422 is driven in such a manner that the pressure chamber 50 is pressurized by the supply of the potential that is negative with respect to the reference potential VREF and that the pressure in the pressure chamber 50 is decreased by the supply of the potential that is positive. However, the relationship between the polarity of the potential supplied to the piezoelectric vibrator 422 and the increase/decrease in the pressure may be reversed. For example, another configuration may be employed in which the supply of a negative potential causes the pressure in the pressure chamber 50 to be decreased and the supply of a positive potential causes the pressure chamber 50 to be pressurized. With this configuration, the piezoelectric vibrator 422 is driven using a waveform obtained by reversing the high potential and the low potential of the driving signal COM in FIG. 5.

### Fourth Exemplary Modification

According to the above-described embodiments, the piezoelectric vibrator 422 that generates longitudinal vibration is given as an example. However, the configuration of the component that causes the pressure in the pressure chamber 50 to be changed (i.e., a pressure generator) is not limited to this. A vibrating body, such as a piezoelectric vibrator that generates flexural vibration or an electrostatic actuator, may be used. In addition, the pressure generator used in the invention is not limited to a component for vibrating the pressure chamber 50 mechanically. For example, a heating element (i.e., a heater) may be used as the pressure generator. Such a heating element causes the pressure in the pressure chamber 50 to be changed by heating the pressure chamber 50 and generating bubbles. That is, the pressure generator used in the invention is encompassed as a component for changing the pressure in the pressure chamber 50. Any method of changing the pressure, such as a piezoelectric method or a thermal method, and any configuration of the pressure generator may be employed.

### Fifth Exemplary Modification

The printer 100 according to the above-described embodiments may be employed in various apparatuses, such as a plotter, a facsimile, and a copier. The usage of the liquid ejecting apparatus devised in the invention is not limited to the printing of images. For example, a liquid ejecting apparatus for ejecting solutions of colorants is used in a manufacturing apparatus for manufacturing color filters of liquid crystal displays. A liquid ejecting apparatus for ejecting conductive materials in the liquid state is used in an electrode manufacturing apparatus for manufacturing electrodes of displays, such as an organic electroluminescence (EL) display and a field emission display (FED). A liquid ejecting apparatus for ejecting solutions composed of living organic materials is used in a chip manufacturing apparatus for manufacturing biochips.

According to the above-described embodiments, the printer 100 of serial type, in which the carriage 12 moves in the main scanning direction with the recording head 22 installed in the carriage 12, is given as an example. However, the invention is also applicable to a printer having a line-type recording head. This recording head has a large length in the main scanning direction so that nozzles are arranged over the entire range of the width of recording paper.

What is claimed is:

1. A liquid ejecting apparatus comprising:
a liquid ejecting section that changes a pressure in a pressure chamber by using a pressure generator so as to eject liquid, which is stored in the pressure chamber, in the form of a droplet from a nozzle; and
a driving-signal generating section that generates a driving signal which operates the pressure generator,
wherein the driving signal includes
a first element that pressurizes the pressure chamber and that makes the liquid in the nozzle protrude to form a liquid pillar, and
a second element that pressurizes the pressure chamber after the first element and that makes a portion of a liquid surface of the liquid, the portion being other than a surface of the liquid pillar, protrude from a position where the liquid surface in the nozzle is in contact with an inner surface of the nozzle, in a direction in which the liquid pillar protrudes, in a state where the liquid pillar has not yet separated from the liquid in the nozzle.

2. The liquid ejecting apparatus according to claim 1,
wherein the driving signal further includes
a third element that is maintained at a potential supplied at the end of the first element after the first element and before the second element.

3. The liquid ejecting apparatus according to claim 1,
wherein the first element includes
a depressurization element that causes a potential change of a first potential difference in a first direction from a certain reference potential so as to decrease the pressure in the pressure chamber, and
a pressurization element that causes a potential change of a second potential difference, which is greater than the first potential difference, in a second direction opposite to the first direction so as to pressurize the pressure chamber.

4. The liquid ejecting apparatus according to claim 1,
wherein the driving signal further includes
a fourth element that decreases the pressure in the pressure chamber after the first element and before the second element.

5. The liquid ejecting apparatus according to claim 4,
wherein a gradient of a potential change of the fourth element is smaller than a gradient of a potential change of the second element.

6. The liquid ejecting apparatus according to claim 1,
wherein the driving signal further includes
an element that decreases the pressure in the pressure chamber after the second element.

7. The liquid ejecting apparatus according to claim 1,
wherein an amplitude of a potential change of the second element is within two-fifths of an amplitude of a potential change of the first element.

8. The liquid ejecting apparatus according to claim 1,
wherein the second element starts when the height of the liquid pillar, which is formed by the first element, with respect to a discharge surface ranges from twice to five times the diameter of the nozzle.

9. The liquid ejecting apparatus according to claim 1,
wherein the height of the liquid surface, which is made to protrude by the second element, with respect to a discharge surface ranges from a half the diameter of the nozzle to three and a half times the diameter of the nozzle.
